(19) United States
(12) Patent Application Publication
(10) Pub. No.: US 2012/0173338 A1
(43) Pub. Date: Jul. 5, 2012

(54) METHOD AND APPARATUS FOR DATA TRAFFIC ANALYSIS AND CLUSTERING

(75) Inventors: Assaf Ariel, Moshav Shoresh (IL); Tomer Tankel, RaAnana (IL)

(73) Assignee: BehavioReal Ltd., Moshav Shoresh (IL)

(21) Appl. No.: 13/496,223

(22) PCT Filed: Sep. 15, 2010
(86) PCT No.: PCT/IL2010/000755

§ 371 Date: Mar. 15, 2012

Related U.S. Application Data
(60) Provisional application No. 61/243,174, filed on Sep. 17, 2009.

(51) Int. Cl. G06Q 30/02

(52) U.S. Cl. 705/14.53

(57) ABSTRACT

A method for selecting network documents as a medium for promotional content. The method comprises capturing a plurality of browsing sessions of a plurality of network users in a communication network, each the browsing session mapping consecutive access to a group of the plurality of network documents by one of the plurality of network users, clustering the plurality of network documents in a plurality of clusters according to the plurality of browsing sessions, selecting at least one of the plurality of clusters as a medium for promotional content, and outputting the at least one selected cluster.

### FIELD AND BACKGROUND OF THE INVENTION

The present invention, in some embodiments thereof, relates to method and system of data analysis and, more particularly, but not exclusively, to method and apparatus for data traffic analysis and clustering.

During the last years, the number of documents which are available on the web, such as web pages, video clips, sound files, and other network accessible data files, increases exponentially. According to various sources, for example www.worldwidewebsize.com, the Indexed Web contains more than 37 billion web pages. Each one of these web pages may incorporate any combination of text, graphics, audio and video content, software programs, and other data. Web pages may also contain hypertext links to other web pages. Web pages are typically stored on computer systems, called web servers, coupled to a network, such as the Internet.

In parallel to the exponential growth of the number of network documents, the number of available promotion spots is increased. Such a variety makes the process of promotion spot selection cumbersome and expensive.

Various methods and systems have been developed to match between a promotion to a certain product and promotion spots. For example, U.S. Pat. No. 6,804,701, filed on May 10, 2001, describes system and method for monitoring and analyzing Internet traffic in an efficient, completely automated, and fast enough manner to handle the busiest websites on the Internet, processing data many times faster than existing systems. The system and method of the present invention processes data by reading log files produced by web servers, or by interfacing with the web server in real time, processing the data as it occurs. The system and method of the present invention can be applied to one website or thousands of websites, whether they reside on one server or multiple servers. The multi-site and sub-reporting capabilities of the system and method of the present invention makes it applicable to servers containing thousands of websites and entire on-line communities. In one embodiment, the system and method of the present invention includes e-commerce analysis and reporting functionality, in which data from standard traffic logs is received and merged with data from e-commerce systems. This invention can produce reports showing detailed “return on investment” information, including identifying which banner ads, referrals, and domains.

Another example is described in U.S. Pat. No. 7,360,251, filed on Apr. 15, 2008 that describes method and system for monitoring users on one or more computer networks, disassociating personally identifiable information from the collected data, and storing it in a database so that the privacy of the users is protected. The system includes monitoring transactions at both a client and at a server, collecting network transaction data, and aggregating the data collected at the client and at the server. The system receives a user identifier and uses it to create an anonymized identifier. The anonymized identifier is then associated with one or more users' computer network transactions. The data is stored by a collection engine and then aggregated to a central database server across a computer network.

Some developments allow internet service providers (ISPs) to control the promotions which are presented to the potential customers in a dynamic manner. For example, U.S. Pat. No. 6,339,761, filed on May 13, 1999, describes a system that provides to ISP precise control over who receives a promotional content. Thus, in accordance with this invention, an ISP provider may offer advertisers precision advertising. An ISP provider has access to precise demographic data on each of the ISP's customers. The ISP provider also has access to data on the periods of usage, including the type of customers accessing the Internet during such periods of usage. With this information, which is available only to the ISP provider, a profile may be compiled by the ISP provider that provides precise information on the ISP customers (e.g., demographic data) and the periods of heaviest Internet access by the various different ISP customer clusters (e.g., 20-35 year old males, retired persons, children, etc.).

### SUMMARY OF THE INVENTION

According to some embodiments of the present invention there is provided a method for selecting network documents as a medium for promotional content. The method comprises capturing a plurality of browsing sessions of a plurality of network users in a communication network, each the browsing session mapping consecutive access to a group of the plurality of network documents by one of the plurality of network users, clustering the plurality of network documents in a plurality of clusters according to the plurality of browsing sessions, selecting at least one of the plurality of clusters as a medium for promotional content, and outputting the at least one selected cluster.

Optionally, the method further comprises anonymizing the plurality of browsing sessions.

More optionally, the anonymizing being performed by periodically changing user identification associated with each the browsing.

Optionally, the clustering comprises providing a list of the plurality of network documents, linking each the browsing session to respective members of the group in the list, and performing the clustering according to the linking.

More optionally, the performing comprises a) clustering the plurality of network documents according to the linking, b) clustering the plurality of browsing sessions according to the a), and c) reclustering the plurality of network documents according to the b).

Optionally, the selecting is performed by identifying at least one keyword in at least one member of the at least one cluster.

Optionally, the selecting is performed by identifying at least one document retrieved in response to a search query is the at least one cluster.

Optionally, the method further comprises providing at least one promotion spot having a high positive responsiveness; wherein the selecting is performed by identifying the at least one promotion spot in at least one member of the at least one cluster.

Optionally, the clustering is performed without analyzing at least one of textual content of the plurality of network documents and linking to and from the plurality of network documents.

Optionally, a set of the plurality of network documents are compressed, the clustering being performed without decompressing the set.

Optionally, the method further comprises identifying an access of a user to a promotional content via at least one of the network document, the at least one selected cluster comprising the at least one network document.

More optionally, the identifying further identifying a browsing pattern leading up to the promotional content according to an analysis of the plurality of browsing sessions; wherein the selecting is performed by identifying the browsing pattern in at least one member of the at least one cluster.

More optionally, the method further comprises identifying a browsing pattern of a user; wherein the selecting is performed by identifying, at least a portion of the browsing pattern in at least one of the plurality of browsing sessions and identifying a at least one link of the at least one browsing session to the at least one network document cluster according to the linking.

Optionally, the method further comprises providing data indicative of at least one access to a promotional content; wherein the selecting is performed by identifying a network document leading up to the at least one access in the at least one cluster.

According to some embodiments of the present invention there is provided a method for assigning promotion content to a browsing user session. The method comprises capturing plurality of browsing sessions of a plurality of network users in a communication network, each the browsing session mapping consecutive access to a group of a plurality of network documents by one of the plurality of network users. monitoring a browsing session a user, identifying a match between the browsing session and at least one of the plurality of browsing sessions during the monitoring, selecting a promotional content according to the match, and presenting the promotional content to the user.

Optionally, the method further comprises a plurality of content tags, each being linked to at least one of the plurality of browsing sessions, the selecting being performed according to a group of the plurality of content tags, the group being linked to the at least one matched browsing session.

Optionally, the method further comprises clustering the plurality of network documents in a plurality of clusters according to a statistical analysis of the plurality of browsing session, the selecting at least one of the plurality of clusters according to the match and selecting the promotional content according to the at least one selected cluster.

Optionally, the method further comprises clustering the plurality of browsing sessions to a plurality of browsing session clusters according to a plurality of relations among the plurality of network documents, the match being with at least one of the plurality of browsing session clusters.

According to some embodiments of the present invention there is provided an apparatus for data traffic analysis and clustering. The apparatus comprises a network interface physically connecting the apparatus to a communication network so as to allow the capturing of a plurality of browsing sessions, each the browsing session mapping consecutive access to a group of a plurality of network documents by one of a plurality of network users, a data analysis module for clustering the plurality of network documents in a plurality of clusters according to an analysis of the plurality of browsing sessions, and an output unit for outputting at least one of the plurality of clusters.

Optionally, the apparatus further comprises a targeting module for selecting at least one of the plurality of clusters according to at least one promotional content criterion.

Optionally, the network interface connecting the apparatus at least on of an internet service provider (ISP) level and an access provider level.

Optionally, the plurality of network documents comprises a member of a group consisting of: a media file, a data file, a peer to peer (P2P) transmission, a search query, a response to a search query, a content retrieved in response to a search query, a compressed file, an encrypted file, and a resource pointed by a universal resource identifier (URI).

According to some embodiments of the present invention there is provided a method for tagging network documents. The method comprises capturing a plurality of browsing sessions of a plurality of Internet users in a communication network, each the browsing session mapping consecutive access to a group of the plurality of network documents by one of an Internet user, clustering the plurality of network documents in a plurality of clusters according to a statistical analysis of the plurality of browsing sessions, tagging each the cluster according to a content analysis, and selecting at least one of the plurality of clusters according to the tagging.

Optionally, the statistical analysis comprises an analysis of at least one of a prevalence of each the network document in the plurality of browsing sessions of and an access instance of each the network document in the plurality of browsing sessions.

According to some embodiments of the present invention there is provided a classification method. The classification method comprises: clustering a plurality of network documents to create a plurality of network document clusters, clustering a plurality of browsing session clusters, each the browsing session mapping consecutive access to a set of the plurality of network documents, creating a plurality of links, each the link is between one of the browsing session clusters and one of the plurality of network document clusters, using the plurality of links to unite at least two of the plurality of network document clusters and at least two of the plurality of browsing session clusters, and using at least one of the united network document clusters and the united browsing session clusters for classifying at least one of a current browsing session of a user and a network document.

Optionally, the classifying comprises using at least one of the united network document clusters and the united browsing session clusters for selecting at least one of a promotional content and a promotional content spot.

According to some embodiments of the present invention there is provided a classification method that comprises clustering a plurality of network tags to create a plurality of tag clusters, clustering a plurality of browsing session clusters, each the browsing session mapping consecutive access to at least one document associated with at least one of the plurality of network tags, creating a plurality of links, each the link is between one of the browsing session clusters and one of the plurality of network document clusters, using the plurality of links to unite at least two of the plurality of tag clusters and at least two of the plurality of browsing session clusters, and using at least one of the united tag clusters and the united browsing session clusters for classifying at least one of a current browsing session of a user and a network document having at least one of the plurality of tags.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volitile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic illustration of an apparatus selecting promotional content spots for a promotion according to browsing analysis of a plurality of users, according to some embodiments of the present invention;

FIG. 2 is a flowchart of method for selecting network documents as a medium for promotional content and/or outputting promotional recommendations according to browsing analysis of a plurality of users, according to some embodiments of the present invention;

FIG. 3 is a flowchart of a process of using anonymized browsing sessions for clustering, according to some embodiments of the present invention;

FIG. 4 is a schematic illustration of a hierarchical linking structure of network documents and browsing sessions, according to some embodiments of the present invention; and

FIG. 5 is a flowchart of a method for clustering network documents, according to some embodiments of the present invention.

### DESCRIPTION OF EMBODIMENTS OF THE INVENTION

The present invention, in some embodiments thereof, relates to method and system of data analysis and, more particularly, but not exclusively, to method and apparatus for data traffic analysis and clustering.

According to some embodiments of the present invention there is provided a method for selecting network documents, for example webpages and web accessible media files, as a medium for promotional content. The method is based on an empirical and/or statistical analysis of browsing traffic that is performed by network users, such as internet users. The method allows clustering, and optionally classifying, documents regardless to their content, for example video files, images, audio files, and webpages. In some embodiments, the method includes capturing a plurality of browsing sessions of the plurality of network users in a communication network, such as the internet. Each browsing session maps consecutive access to network documents by one of the network users. Now, the network documents are clustered according to the plurality of browsing sessions. This allows selecting one or more clusters of network documents as a medium for promotional content. As the clustering is based on traffic analysis, diversions which are induced from textual and/or linking analysis may be avoided. The selected clusters are outputted to allow, for example, the embedding of the promotional content therein.

Optionally, the traffic analysis that allows the clustering is based on links between the browsing sessions and network documents which are related thereto.

According to some embodiments of the present invention there is provided an apparatus for clustering, and optionally classifying, network documents. The apparatus includes a network interface, such as a physical network interface card, that physically connects the apparatus to a communication network, optionally at the ISP level and/or the access provider level, so as to allow the capturing browsing traffic. The capturing of the browsing traffic allows identifying browsing sessions that maps consecutive access to network documents by a network user. The apparatus further comprising a data analysis module for clustering network documents according to an analysis of the browsing traffic, for example analysis of the browsing sessions. Each cluster of network documents may be classified according to browsing, textual, and/or contextual characteristics which are common to the network documents it clusters. Optionally, the apparatus includes a targeting module for selecting one or more of the clusters according to one or more promotional content criterions. In such a manner, clusters of network documents may be selected for a targeted promotion that matches characteristics of their network documents.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

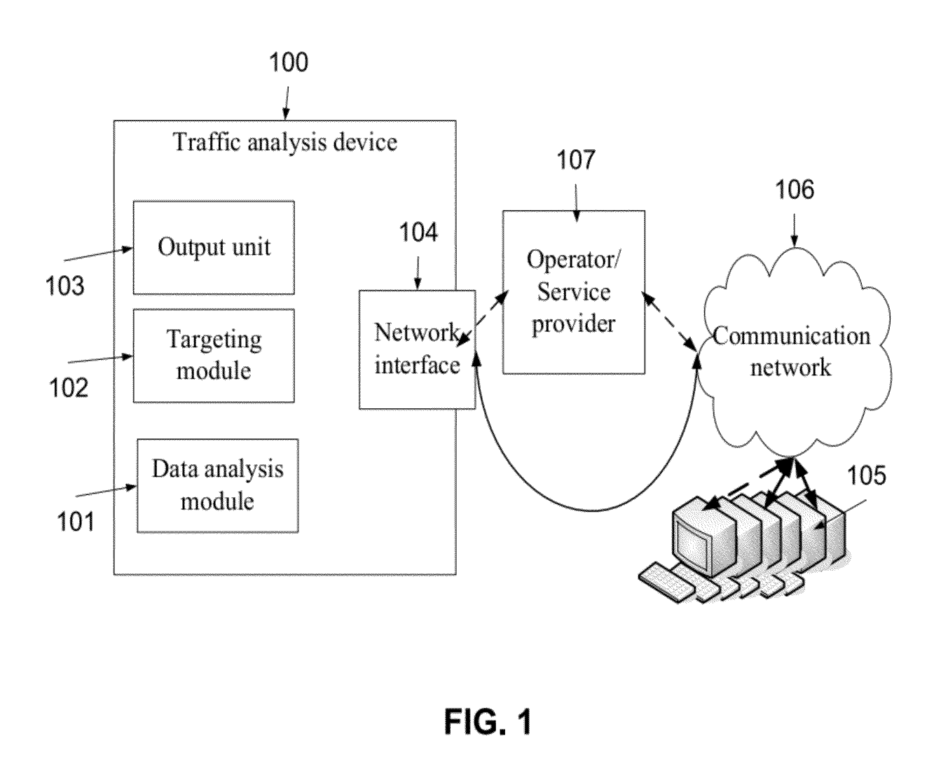

Reference is now made to FIG. 1, which is a schematic illustration of a traffic analysis device 100 for selecting promotion spots according to analysis of browsing traffic pertaining to a plurality of network users 105, according to some embodiments of the present invention. As used herein, browsing traffic means traffic pertaining to an act of searching and/or accessing automated information system storage over a computer network.

The traffic analysis device 100 is connected to a communication network, such as the Internet 106, for example at the internet service provider (ISP) and/or the access provider level. In such an embodiment, the traffic analysis device 100 includes a network interface 104 for physically interconnecting between the traffic analysis device 100 and the communication network 106, for example one or more physical network interface cards (NICs).

The network interface 104 allows capturing and analyzing browsing traffic, such as browsing sessions which are preformed by the plurality of network users, using a plurality of client terminal 105, such as personal computers, laptops, Smartphones and personal digital assistant (PDAs), which are connected to the Internet via the related ISP 107. As used herein, a browsing session means a set of one or more network documents which are consecutively accessed by a user, optionally over a predetermined period, such as several minutes, hours, and days. For example, a browsing session may include addresses, for example uniform resource locators (URLs) of the webpages a user visited over a period of 15 minutes and/or, over a period that lasts as long as the user actively browses. As used herein, a network document means a webpage, a media file, a data file, a peer to peer (P2P) transmission, a search query, a response to a search query, a content retrieved in response to a search query, and a resource pointed by a universal resource identifier (URI). Optionally, a log of browsing sessions is created by the traffic analysis device 100 every predefined period, for example every several minutes, hours, days, weeks, months, years and/or any intermediate period.

The connection of the network interface 104 to the physical network 106 allows processing all the browsing sessions in a data transmission rate of the transmission medium to which it is connected, for example at the wire speed of the cable. Optionally, the network interface 104 includes a packet sniffer that intercepts and logs traffic passing over the communication network 106. As data streams travel over the communication network 106, the sniffer captures each packet and eventually decodes and analyzes its content, for example according to the appropriate request for comments (RFC) standard or other suitable specifications. The decoding allows detecting and documenting the webpage addresses, header fields, access time, selected keywords, and/or any other significant parameter that can be used for the browsing analysis.

Optionally, the traffic analysis device 100 includes a targeting module 102. The targeting module 102 allows a client, such as a user and/or a server, for example an ad server, to select one or more clusters of network documents and/or to identify, in real time, a targeted promotional content for browsing user according to her current browsing session. The clusters are selected according to one or more criterions, for example as described below.

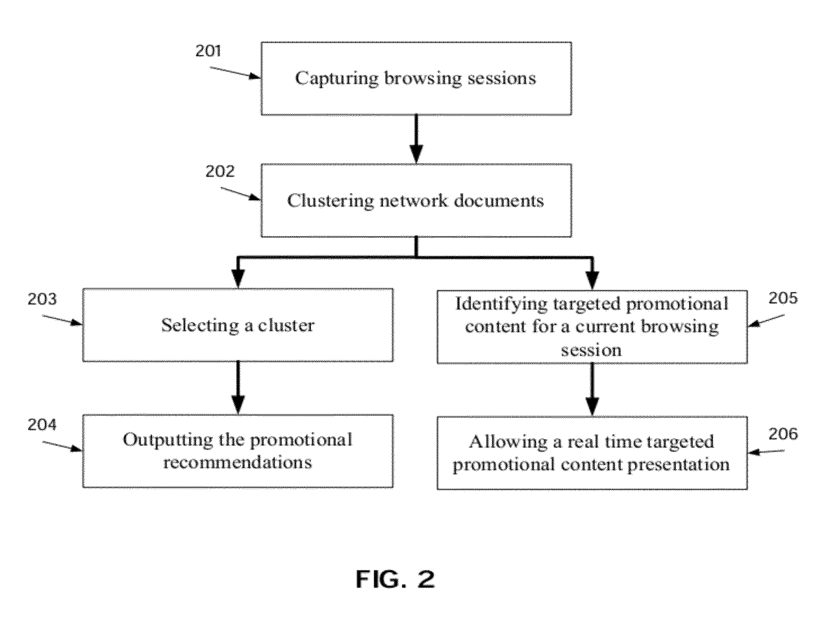

Reference is now also made to FIG. 2, which is a flowchart of method for selecting network documents as a medium for promotional content and/or outputting promotional recommendations, according to some embodiments of the present invention. The promotional recommendations may be outputted according to browsing analysis of a plurality of users, for example based on a classification of network documents and/or browsing sessions as described below. First, as shown at 201, browsing sessions are captured, for example using the traffic analysis device 100.

According to some embodiments of the present invention, the captured browsing sessions are anonymized. In such a manner, the storage and/or the analysis of the browsing sessions do not violate the privacy of the users. Optionally, random identification (ID) values are used for tagging the user sessions, for example instead of the public address thereof, for example their internet protocol (IP) address and/or a cookie ID. Optionally, the ID values, referred to herein as anonymous identifiers, are internal values which are accessed only by internal processes of the device 100, for example by the data analysis module 101. Optionally, the anonymous identifiers are replaced every predefined period, for example 10 minutes, 1 hour, 24 hours, and the like. Optionally, the anonymous identifiers are replaced every predefined number of network documents which are visited by the user. Optionally, the number of network documents and/or the predefined period is selected to accord with a session length and/or period. In such a manner, data pertaining to a certain user does not accumulate under a common identifier and therefore cannot be easily combined, merged and/or adapted to learn about the user browsing patterns and/or habits. Optionally, any duplication and/or copying of the documented session induce swapping the anonymous identifiers.

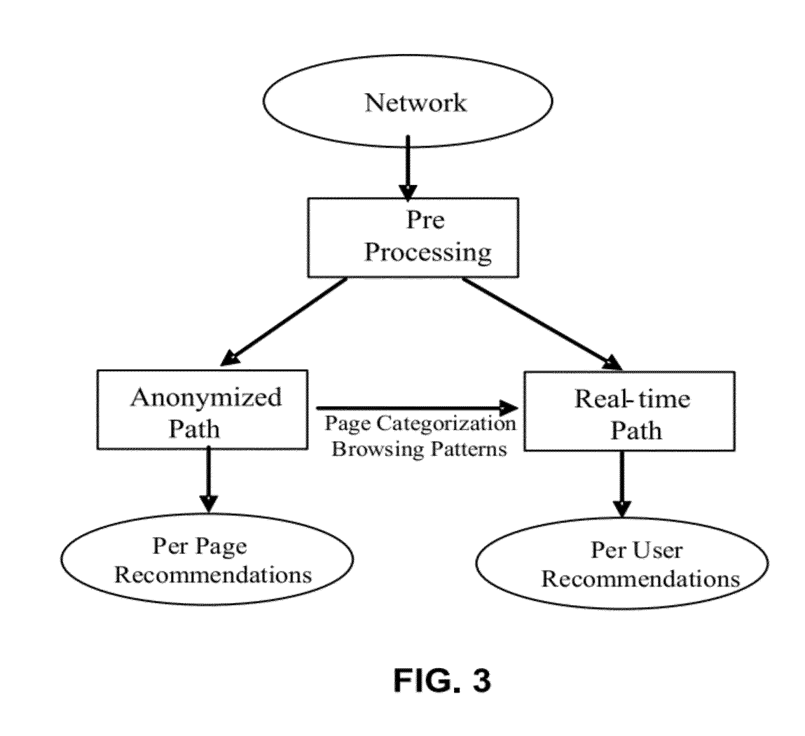

Additionally or alternatively, one or more current interests of each user are identified. As a correlation back to the user or to a specific client terminal may be required, identification, such as an IP address or a unique identification (ID) number, is stored. Optionally, in order to maintain a high level of privacy, the identification information and/or the current set of interests are stored for a limited term. Optionally, the set of user interests, referred to as an interest vector, is extracted from each browsing session in real time. As used herein, real time means the time that it takes a process to occur, for example while the user browses and/or during the browsing session. For example FIG. 3 depicts a flowchart of a clustering method that is based on data from the anonymized browsing sessions and/or from an interest vector that may be based on the anonymized browsing sessions, according to some embodiments of the present invention. The interest vector is based on an estimation of the current interests of each user. Optionally, the IP address is temporally stored to allow a back correlation. As the browsing sessions may be documented in vectors which are stored for no more than several minutes and/or hours, the privacy of the users is kept.

In the real time path, the interest vectors are calculated by identifying which network document clusters are associated with browsing session clusters to which the current browsing session of the user is related. The network document clusters are optionally associated with promotional content and/or content tags, which are selected according to content that prevails in the clustered network documents, for example according to known methods. Optionally, the promotional content is presented to the user during the browsing session, for example as pop ups and/or banners in webpages she is visiting. In such an embodiment, the promotional content is targeted according to the current browsing of the specific user.

As depicted in FIG. 3 and described above, the browsing session clusters and the network document clusters allows generating promotional content recommendations per network document, for example per webpage, and per user, for example according to a current browsing session thereof, in real time. Optionally, the recommendations are provided without revealing the identity of any of the browsing users.

In such an embodiment, the data analysis is performed in real time, for example according to the network documents classification and/or respective browsing patterns which are extracted from the anonymized sessions. The weight of each user interest is gradually reduced with time so that newer interests have more weight. In such an embodiment, the weight of the interest vector is fading with time.

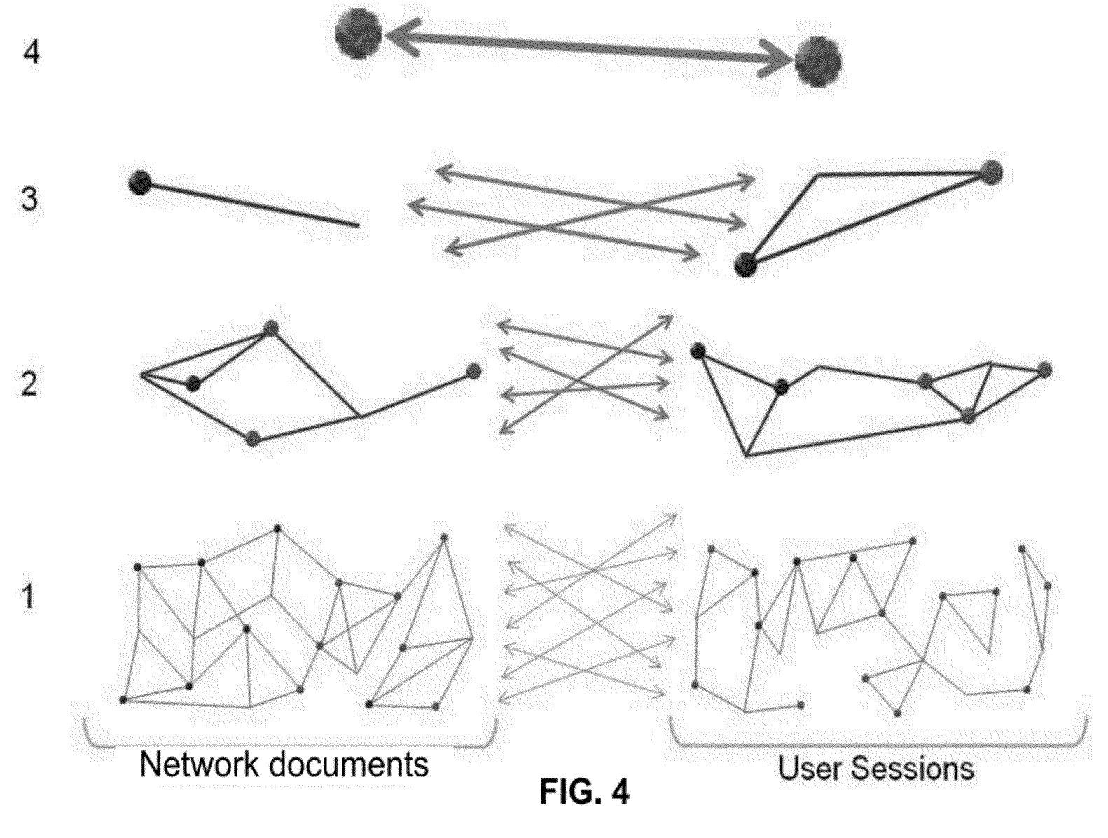

Now, as shown at 202, the plurality of network documents are clustered according to the captured browsing sessions, for example according to the aforementioned log. Optionally, the clusters are arranged in a connected model, such as a tree or a graph, for example as shown in each one of the datasets presented in FIG. 4. Each cluster bunches network documents that have one or more common characteristics. Optionally, the clustering is performed as a soft hierarchical bi-clustering algorithm that optionally follows algebraic multi grid methodology, for example as defined in A. Brandt, S. McCormick, and J. Ruge. Algebraic multigrid (amg) for sparse matrix equations. In D. J. Evans, editor, Sparsity and its applications, pages 257-284, Cambridge, 1984, which is incorporated herein by reference.

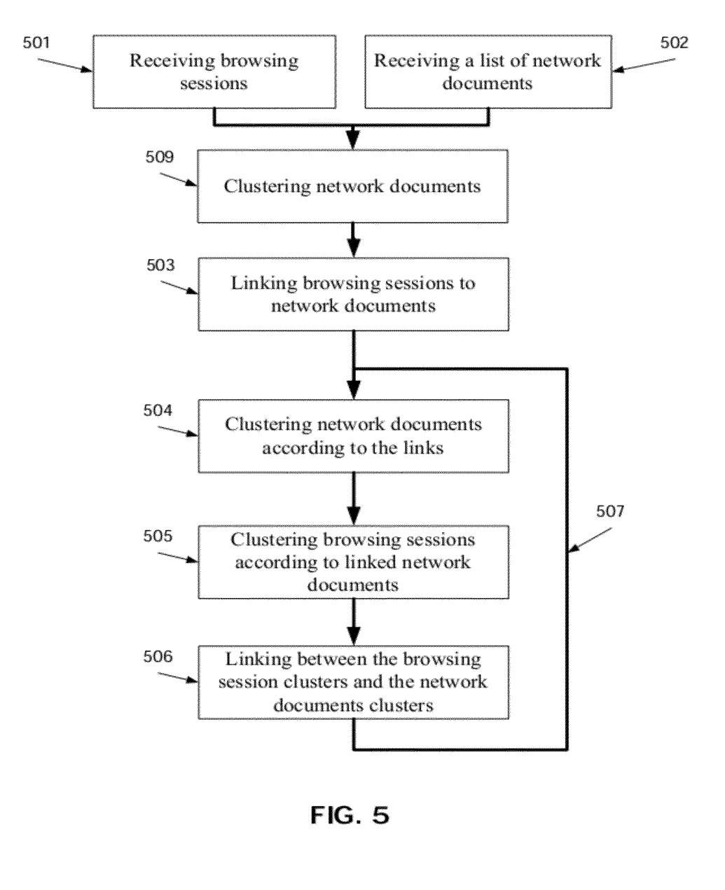

Reference is now made to FIG. 5 that is a flowchart of a method for clustering the network documents, according to some embodiments of the present invention. As shown at 501, the browsing sessions are received, for example the aforementioned log. In addition, as shown at 502, a list of network documents is received, for example a list of links to selected webpages comprising promotion spots, such as banners, popup windows, flash ads, messenger service ads, and text links.

As further described below, the method is a bottom up process in which an aggregation process is repeated to construct links and clusters as defined below. The aggregation of usage information facilitate a process in which clusters of network documents and clusters of browsing sessions are iteratively clustered to create bigger clusters so as to create an aggregated instance that consists a limited number of clusters.

Now, as shown at 503, each browsing session is linked to one or more network documents which are related thereto. The linking connects each browsing session to network documents which have been visited during its course. Optionally, the linking is also performed according to network documents which are similar to network documents which have been visited during its course. Optionally, each such link, which may be referred to herein as a session-document link, receives a link value. The link value is determined according to a statistical relation between the browsing session and the network document that is linked thereto. For example, the link value may be determined according to time of browsing, the frequency of browsing during the session, and the place in the order of visits during the browsing session.

Optionally, each network document in the list is tagged with one or more content tags which are indicative of the content represented by the network document. Such content tags may include the metadata of the network documents, or extracted therefrom, provided by analyzing the content of the network documents and/or the links from and/or to the network documents and/or by any other known tagging processes. Optionally, the content tags are used for matching promotional content to the network documents of selected websites or advertisers.

Optionally, as shown at 509, initial clustering of the network documents is performed. Optionally, the clustering is based on interrelations between the network documents, for example on a similarity score that is given to a relationship between any pair of clustered network documents, for instance according a match between their metadata. Optionally, the network documents of the list are clustered according to common and/or otherwise associated content tags. In such an embodiment, the network documents with content tags pertaining to a common field of interest, dates, and/or content, are clustered. The relationship between the content tags may be determined according to various known methods, for example according to a map of semantic relation between words and phrases.

Now, as shown at 504, the network documents of the list and/or the initial clusters which are formed according to the network document interrelations, as described above, are clustered according to mutual statistical relations which are reflected from the aforementioned browsing session-network document links.

As shown at 505, the received browsing sessions are clustered according to their similarity, optionally in a second-level clustering. For example, the clustering may be performed according to a relation between visited network documents and network document clusters, optionally generated as described above in relation to 504.

Optionally, the clustering of the network documents in the list and/or the browsing sessions is performed by a soft clustering. In such a manner, each network document and/or browsing session may be in a number of clusters.

Now, as shown at 506, links between the next-level browsing session clusters to the next-level network documents clusters are calculated. The links of each browsing session cluster connect it to network document clusters containing the network documents which are dominantly accessed by browsing sessions of this browsing session cluster. Optionally, the link values are averaged, for example according to all the link values of members of the associated browsing session cluster and/or network document cluster. Optionally, a link having a link value below the average is removed and/or otherwise ignored.

As shown at 507, blocks 504-506 are repeated iteratively. For example, FIG. 4 depicts the clusters which are formed in four iterations of the process. During each iteration, clusters, which are based on the clustering of network documents and browsing sessions in the previous iteration, are formed and linked. In such a manner, links are used for creating new clusters that are later used for clustering links and so on and so forth. Such a hierarchical linking structure allows using data gathered in one iteration to unite clusters in the following iteration. The remaining session-document cluster links are now used for determining the final clusters of the network documents.

According to some embodiments of the present invention, the bi clustering process that is depicted in blocks 504-506 is held between browsing sessions and content tags which are associated with the network documents. In such an embodiment, records of a list of content tags are linked to records of the list of network documents. In such a manner, a link between a browsing session and a content tag may be established via a network document record. The clustering may be performed according to mutual statistical relations, which are reflected from browsing session-content tags links.

Reference is now made to an exemplary implementation of the clustering process. The exemplary process is a bottom up process in which aggregation steps are repeated a number of times. In each aggregation step, an aggregated instance of a respective level is constructed according to usage information from an aggregated instance of a previous level. Finally, the aggregated instance consists of few content and user session clusters.

First, the network documents in the list and the network sessions are arranged in a bi-partite graph. V denotes document network nodes, U denotes browsing sessions, and E denotes links where E={(u, v)|uεU, vεVᵤ}. Each browsing session u is connected to the set Vᵤ [symbol] V of content elements accessed by this user session.

The clustering is performed according to three stages.

First, a similarity score, referred to herein as a pair similarity (PS) score, is calculated for each pair of browsing session clusters and for each pair of network document clusters. The PS score is optionally a measure of statistical similarity between these clusters. The PS may be calculated according to various similarity measures and methods which are known in the art, for example as described in Foundations of statistical natural language processing (1999) By Christopher D. Manning, Hinrich Schiitze, Page 299, which is incorporated herein by reference.

Then, the clusters are nominated for selection. For clarity, Pᵥ denotes the selected network documents and Pᵤ denotes the selected browsing sessions.

Each document network and/or browsing session that is not in Pᵥ and/or Pᵤ is assigned with a parent cluster from Pᵥ and/or Pᵤ. One or more parents are assigned to an unselected child node c, for example as follows:

$$Q = {\sum }_{v ∈ {Π}_{c}} PS ( c , v ) \\ Q > γ {\sum }_{v ∈ V} PS ( c , v ) , \qquad Equation 1$$

where γ<1 is an aggregation factor.

For each of the parents of node c, denoted herein as Pᵢ, where PᵢεΠ_{c} of child c, a relative score, denoted herein as s_{c}(pᵢ), is defined. The relative score is calculated as the PS score between c and pᵢ divided by the total of the separate PS scores between c and all its parents Π_{c}. In such a manner, p of an (l) level cluster is considered as one of the children of (l+1) level cluster while its relative score is sₚ(p)≡l. In such a manner, the following is received for each (l) level node:

$${\sum }_{i ∈ {Π}_{v}} {s}_{c} ( i ) = 1 ; ∀ v ∈ V \\ {\sum }_{i ∈ {Π}_{u}} {s}_{c} ( i ) = 1 ; ∀ u ∈ U . \qquad Equation 2$$

Now, the links between the browsing session clusters and the network document clusters are computed, for example by interpolation. Each cluster in Pᵥ and/or Pᵤ of an (l+1) level cluster heads respective child network documents and/or respective child browsing sessions. A mass, denoted herein as m, is calculated for each (l+1) level cluster p according to the number of v or u nodes, namely first level nodes, which are part of it, for example calculated as follows:

m [symbol] 1 [symbol] (v)≡1∀vεV

m [symbol] 1 [symbol] (u)≡1∀uεU

m [symbol] l+1 [symbol] (p)−Σ_{jεC}_{ₚ}m^{(l)}(j)sⱼ(p), Equation 3:

where Cₚ⊂V and/or Cₚ⊂U is the children set of the parent cluster pεPᵥ and/or pεPᵤ. Each cluster has a different m as it is formed by different child nodes. However, the total value of all masses of all the network document clusters and all the browsing session clusters is constant for all hierarchy levels. This may be shown by summing over all parents in Pᵥ and/or Pᵤ, for example as follows:

$${\sum }_{v ∈ {P}_{v}} {m}^{( l + 1 )} ( v ) = {\sum }_{v ∈ V} {m}^{( l )} ( v ) {\sum }_{u ∈ {P}_{u}} {m}^{( l + 1 )} ( u ) = {\sum }_{u ∈ U} {m}^{( l )} ( u ) \qquad Equation 4$$

where the sum of each child is arranged using Equation 2.

The relative m of a child cluster c and its parents pᵢ is the relative portion of the mass of this child in the mass of its parent, for example given as follows:

$$\frac{{m}^{〈 l 〉} ( c ) {s}_{c} ( {p}_{i} )}{{m}^{〈 l + 1 〉} ( {p}_{i} )}$$

The (l+1) level links between each (l+1) level browsing session cluster and each (l+1) level network document cluster are determined by a union of (l) level links between the (l) level members of the (l+1) level clusters. The link value of each (l) level link between a child browsing session and a child network document cluster is multiplied by the relative mass of the child browsing session cluster in the (l+1) level browsing session cluster and the child network document cluster in the (l+1) level network document cluster. The multiplied link values are summed over all the linked child members connecting the (l+1) level clusters. The links with smaller values are neglected.

Reference is now made, once again, to FIGS. 1 and 2. As shown at 203, one or more clusters are now selected from the aforementioned network document clusters. The selection is optionally performed according to one or more promotional content criterions which match one or more identifiers in the network documents of the clusters.

Optionally, the selection may be performed according to a keyword analysis of the network documents of each cluster. In such an embodiment, the promotional content criterions include one or more selected keywords. Then, the selected keywords are searched for in the clusters. Optionally, the clusters are ranked according to the presences of these selected keywords in its network documents. In such a manner, the clusters with higher ranks may be selected, manually and/or automatically, for promotion. It should be noted that in such a manner, keywords which are present in some documents, allow identifying clustered documents which do not have these keywords, or any keywords, for example untagged video files, audio files, and images.

Additionally or alternatively, the selection may be performed according to a search engine indexing and/or ranking. In such an embodiment, the promotional content criterions includes one or more keywords and the cluster is selected according to the presence of a network document that is included in the response to a search query having these keywords and/or network documents which are linked by such a network document.

Additionally or alternatively, the selection may be performed according to the customer compliance history. In such an embodiment, the promotional content criterions may include one or more network documents in which a certain promotion has been presented and achieved high positive responsiveness. An example for such a network document is a webpage presenting a banner achieving a high click-through rate. Another example is a media file achieving a high click-through rate to a website of a promoted product. Optionally, promotional content criterions may include the promotion, and such documents are gathered from related advertisement (ad) servers.

Optionally, as shown at 204, one or more promotional content recommendations are outputted, forwarded, and/or presented to one or more clients, optionally in real time. Optionally, each promotional content recommendation includes suggested advertisement spots from the clustered network documents.

In such a manner, clients may acquire concurrent data pertaining to network documents which are accessed by a target audience that accesses documents having selected promotional content criterions, such as keywords. Moreover, the relation of a network document to a certain cluster may be used for recommending a promotional content for it.

Optionally, the promotional content recommendations are provided to an ad-server or a portal that asks which campaign best matches a webpage. As described above, the recommendation is based not on the content of that specific page, but on the aggregated knowledge from the various user sessions than include the webpage.

According to some embodiments of the present invention, as shown at 205 and outlined above, a current browsing session of a user, such as an internet user is matched with the browsing session clusters so as to allow the identification of promotional content which is targeted for the current browsing session. As described above, browsing session clusters are created according similarity of the clustered browsing sessions to common network documents which are connected thereto. The matching of the current browsing session to one of the clusters allows selecting promotional content and/or content tags, which are associated with the matched cluster, as described above. The content tags may be used to acquire promotional content. As shown at 206, the promotional content, which is selected or acquired according to content tags, is presented to the user during the current browsing session, in real time. Optionally, the promotional content is presented by an advertisement server that is instructed according to the browsing session clusters which are selected are depicted in block 205. The content may be presented as a pop up and/or on any advertisement spot located in visited webpages and/or other network documents, for example on a widget that is presented to the user and/or as a banner and/or a pop up that is superimposed on a display of a visual content, such as a video stream.

For example, a client may be an ad-server that requests an indication of which promotional content matches a certain browsing session of a user. In such a manner, the ad-server may add promotional content to webpages which are visited by the user according to the indication. Such a targeted promotional content placing increases the exposure of a related campaign to customers which their browsing session indicates that they are interested in promoted service and/or product.

As described above, the aforementioned clustering is based on browsing sessions and not, or not only, on the content of the network documents. As the clustering method is based on an empiric browsing analysis, it avoids undesirable diversions induced by content based clustering. Unlinked network documents are clustered according to user behavior and not only according to estimated semantic and/or taxonomic relations. In such a manner, untagged documents, such as media files, documents which are tagged in different representations, such as languages and/or according to different logics, and documents having relationships that cannot be discovered using known semantic and/or taxonomic methods are clustered in groups based on actual access. In other words, documents are clustered according the manner they are actually explored by users and not according to an estimation pertaining to their content and/or links.

Optionally, the content of the network documents is provided in various languages, encryptions, and/or formats. For example, the network documents may include video files, audio files, text files in various languages, and/or encrypted files. As no content analysis is needed for performing the clustering, the quality of the outcome remains the same. Optionally, some or all of the clustered files are compressed. As no or little content analysis is needed, the files may be clustered without a substantial or any decompression. For example, if content tags are used for linking, as described above, only the metadata portion of the compressed file may be decompressed for tagging.

According to some embodiments of the present invention, the clustering data may be used to identify and/or calculate browsing patterns correlated with specific user interests. As described above, each browsing session that is documented in a browsing session cluster includes a number of network documents which are consecutively visited by a browsing user. Optionally, one or more common browsing patterns are identified by analyzing these sessions. The common pattern may be a common set of visited network document, a common order of visiting network documents or network document having common characteristics, a common time spent browsing one or more selected network documents and the like. Example for characteristics of network documents may be a type, a genre, a publisher, a language, and/or any other descriptive characteristic.

Browsing patterns identified in each document cluster, for example as described above, may be used for promoting users in real time. For example, a browsing pattern of a user may be analyzed in real time, based on a network session optionally captured as described above, and matched with one or more browsing patterns which are associated with each network document cluster. When a match is found, the user may be presented with promotional content, such as an advertisement, which has been associated the network document cluster. The matching also allows estimating the interests of the user according to user interests of the matching clusters.

It should be noted that as a pattern is matched, a set of multiple user actions is taken into account. As the set reflects more than a single user selection, the quality of the matching is relatively high. Furthermore, by matching patterns, unintended browsing actions, such as URL misspelling and unintentional clicking on a popup window and/or a banner are either ignored or receive a low weight.

According to some embodiments of the present invention, the network document clusters may be used to identify new promotion spots for a published promotional content. As described above, the browsing sessions document sets of network documents which are consecutively accessed by the user. When a user accesses a promotional content, for example by clicking on a banner, she expresses her interest in the promotional content. Optionally, an analysis of the network sessions allows detecting network documents which are common to various network sessions leading the user up to or via the accessed promotional content. Examples for such network documents may be a first webpage linking to a second webpage hosting the promotional content and/or a link to the promotional content, a media file that is presented in and/or linked from a webpage hosting the promotional content, and the like.

Optionally, a browsing pattern leading up to the accessed promotional content is identified. The identified browsing pattern is then matched with browsing patterns associated with clusters, for example as described above. The identification of a match allows the outputting of a list of recommended promotion spots according to the network documents leading up to the promotional content. In such a manner, new promotion spots, which are likely to attract people interested in the accessed promotional content, are recommended as promotion spots. Such recommendations allow dynamically adjusting a campaign according to browsing sessions of users who express interest in the promotional content. Optionally, the campaign adjustment is performed automatically, according to one or more matches with one or more users.

Optionally, the analysis of the browsing pattern leading up to the promotional content access may also be analyzed to determine preferred access timing. For example, tracks of network documents leading up to an accessed promotional content are analyzed to identify timing or sequence in which users tend to access the promotional content. The detected sequence and/or timing may be used for generating triggers for presenting the promotional content. For instance, pop-ups with the promotional content may be presented at the detected timing and banners may be presented to user how browsed along the detected sequence, at the suitable network document along the sequence.

Additionally or alternatively, the analysis of the browsing pattern leading up to the promotional content access allows empirically detecting a sequence and/or timing in which the user tends to access promotional content. In such an embodiment, promotional content may be presented to the user after she browsed along a selected sequence and/or at the timing she tends to access promotional data. The leading up browsing pattern and/or timing may be used for identifying a preferred period in which certain actions are performed, optionally by certain user. Such actions may be purchasing products and/or services. Optionally, the analysis includes data pertaining to commercial affectivity of the browsing session, for example, an actual purchase of a promoted service and/or a product. This data may be detected from the analysis of the current browsing and/or provided by other sources.

According to some embodiments of the present invention, the bi clustering process allows presenting browsing recommendations to users in real time. In use, the browsing session of the user is matched with one of the browsing session clusters. The matching allows detecting one or more clusters of network documents which are linked to the matching browsing session cluster. These network documents may be presented to the user a browsing recommendation. It should be noted this recommendation is based on empirical analysis of the browsing of other users and not only on semantic analysis or linking analysis of the documents. Such a recommendation, which is based on the wisdom of crowds, namely the actual browsing selection of the users, provides up-to-date information about which websites are actually visited during browsing sessions which are similar to the browsing session of the user. This may enhance the browsing experience of the user, for example for users that brows via their limited user interface, such as a user interface of a mobile device. It should be noted that the monitored browsing sessions may be analyzed and/or clustered according to the relation of the users to certain demographic groups, such as a country and/or a geographical area. In such a manner, browsing data pertaining to users with one or more common characteristics may be analyzed.

Reference is now made, once again, to FIG. 1. As outlined above, the traffic analysis device 100 may be installed at the ISP level and/or the access provider level, so as to allow the capturing browsing traffic. Usually a certain ISP or access provider provides services to a group of users from a common geographic location. In such an embodiment, a promotional content that is selected for a browsing user may be from local advertisers which are looking for targeted promotion for local clients. Furthermore, the clusters of browsing sessions and the network documents reflect browsing patterns and habits which characterize the ISP's subscribers and therefore may be used for local advertisement campaigns. For example, local promotions may be matched with the network document clusters which include network documents browsed by the ISP subscribers.

It is expected that during the life of a patent maturing from this application many relevant systems and methods will be developed and the scope of the term system, node, and a computational unit is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A method for selecting one or more network documents, comprising:
capturing a plurality of browsing sessions of a plurality of network users in a communication network, each said browsing session mapping consecutive access to a group of a plurality of network documents by one of said plurality of network users;
clustering said plurality of network documents in a plurality of clusters according to said plurality of browsing sessions;
identifying a new browsing session of a network user;
matching said new browsing session with at least one of said plurality of clusters; and
selecting at least one member of said at least one matched cluster for generating at least one recommendation for said network user.

2. The method of claim 1, further comprising anonymizing said plurality of browsing sessions.

3. The method of claim 2, wherein said anonymizing being performed by periodically changing user identification associated with each said browsing.

4. The method of claim 1, wherein said clustering comprises:
providing a list of said plurality of network documents;
linking each said browsing session to respective members of said group in said list; and
performing said clustering according to said linking.

5. The method of claim 4, wherein said performing comprises:
a) clustering said plurality of network documents according to said linking;
b) clustering said plurality of browsing sessions according to said a); and
c) reclustering said plurality of network documents according to said b).

6. The method of claim 1, wherein said matching is performed by identifying at least one keyword extracted from said new browsing session in at least one member of said at least one cluster.

7. The method of claim 1, wherein said matching is performed by identifying at least one document retrieved during said new browsing session in response to a search query in at least one member of said at least one cluster.

8. The method of claim 1, wherein said recommendation is a promotional recommendation; further comprising providing at least one promotion spot having a high positive responsiveness; wherein said matching is performed by identifying said at least one promotion spot in at least one member of said at least one cluster.

9. The method of claim 1, wherein said clustering is performed without analyzing at least one of textual content of said plurality of network documents and linking to and from said plurality of network documents.

10. The method of claim 1, wherein a set of said plurality of network documents are compressed, said clustering being performed without decompressing said set.

11. The method of claim 1, wherein said recommendation is a promotional recommendation; further comprising identifying an access of a user to a promotional content via at least one of said plurality of network documents, said at least one selected cluster comprising said at least one network document.

12. The method of claim 11, wherein said identifying further identifying a browsing pattern leading up to said promotional content according to an analysis of said plurality of browsing sessions; wherein said selecting is performed by identifying said browsing pattern in at least one member of said at least one cluster.

13. The method of claim 5, further comprising identifying a browsing pattern of a user; wherein said matching is performed by identifying, at least a portion of said browsing pattern in at least one of said plurality of browsing sessions and identifying a at least one link of said at least one browsing session to said at least one cluster according to said linking.

14. The method of claim 1, wherein said recommendation is a promotional recommendation; further comprising providing data indicative of at least one access to a promotional content; wherein said matching is performed by identifying a network document leading up to said at least one access in said at least one cluster.

15. A method for assigning promotion content to a browsing user session, comprising:
capturing plurality of browsing sessions of a plurality of network users in a communication network, each said browsing session mapping consecutive access to a group of a plurality of network documents by one of said plurality of network users;
monitoring a browsing session a user;
identifying a match between said browsing session and at least one of said plurality of browsing sessions during said monitoring;
selecting a promotional content according to said match; and
presenting said promotional content to said user.

16. The method of claim 15, further comprising a plurality of content tags, each being linked to at least one of said plurality of browsing sessions, said selecting being performed according to a group of said plurality of content tags, said group being linked to said at least one matched browsing session.

17. The method of claim 15, further comprising:
clustering said plurality of network documents in a plurality of clusters according to a statistical analysis of said plurality of browsing sessions, and
selecting at least one of said plurality of clusters according to said match;
wherein said selecting is performed according to said at least one selected cluster.

18. The method of claim 15, further comprising clustering said plurality of browsing sessions to a plurality of browsing session clusters according to a plurality of relations among said plurality of network documents, said match being with at least one of said plurality of browsing session clusters.

19. An apparatus for data traffic analysis and clustering, comprising:
a network interface physically connecting said apparatus to a communication network so as to allow the capturing of a plurality of browsing sessions, each said browsing session mapping consecutive access to a group of a plurality of network documents by one of a plurality of network users;
a data analysis module for clustering said plurality of network documents in a plurality of clusters according to an analysis of said plurality of browsing sessions; and
an output unit for outputting at least one of said plurality of clusters.

20. The apparatus of claim 19, further comprising a targeting module for selecting at least one of said plurality of clusters according to at least one promotional content criterion.

21. The apparatus of claim 19, wherein said network interface connecting said apparatus at least on of an internet service provider (ISP) level and an access provider level.

22. The apparatus of claim 19, wherein said plurality of network documents comprises a member of a group consisting of: a media file, a data file, a peer to peer (P2P) transmission, a search query, a response to a search query, a content retrieved in response to a search query, a compressed file, an encrypted file, and a resource pointed by a universal resource identifier (URI).

23. A method for tagging network documents, comprising:
capturing a plurality of browsing sessions of a plurality of Internet users in a communication network, each said browsing session mapping consecutive access to a group of said plurality of network documents by one of an Internet user;
clustering said plurality of network documents in a plurality of clusters according to a statistical analysis of said plurality of browsing sessions;
tagging each said cluster according to a content analysis; and
selecting at least one of said plurality of clusters according to said tagging.

24. The method of claim 23, wherein said statistical analysis comprises an analysis of at least one of a prevalence of each said network document in said plurality of browsing sessions of and an access instance of each said network document in said plurality of browsing sessions.

25. A classification method comprising:
clustering a plurality of network documents to create a plurality of network document clusters;
clustering a plurality of browsing session clusters, each said browsing session mapping consecutive access to a set of said plurality of network documents;
creating a plurality of links, each said link is between one of said browsing session clusters and one of said plurality of network document clusters;
using said plurality of links to unite at least two of said plurality of network document clusters and at least two of said plurality of browsing session clusters; and
using at least one of said united network document clusters and said united browsing session clusters for classifying at least one of a current browsing session of a user and a network document.

26. The method of claim 25, wherein said classifying comprises using at least one of said united network document clusters and said united browsing session clusters for selecting at least one of a promotional content and a promotional content spot.

27. A classification method comprising:
clustering a plurality of network tags to create a plurality of tag clusters;
clustering a plurality of browsing session clusters, each said browsing session mapping consecutive access to at least one document associated with at least one of said plurality of network tags;
creating a plurality of links, each said link is between one of said browsing session clusters and one of said plurality of network document clusters;
using said plurality of links to unite at least two of said plurality of tag clusters and at least two of said plurality of browsing session clusters; and
using at least one of said united tag clusters and said united browsing session clusters for classifying at least one of a current browsing session of a user and a network document having at least one of said plurality of tags.

28. The method of claim 1, wherein said at least one recommendation is generated and provided to said user during said new browsing session.

29. The method of claim 1, wherein said clustering is performed according to said plurality of browsing sessions and at least one demographic characteristic of said plurality of network users.

30. The method of claim 1, wherein said plurality of network documents comprises a plurality of untagged video or audio files.

31. The method of claim 1, wherein said recommendation is a promotional recommendation for placing promotional content in at least one member of said at least one cluster.
